(19) United States
(12) Patent Application Publication
(10) Pub. No.: US 2014/0140076 A1
(43) Pub. Date: May 22, 2014

(54) ILLUMINATED INTERFACE CABLE

(71) Applicant: XENTRIS WIRELESS, LLC, Addison, IL (US)

(72) Inventors: Terrell MORROW, Elgin, IL (US); William CHRISTY, South Elgin, IL (US); Mark William LOPOTKO, Carol Stream, IL (US); Christopher WHETSTONE, Aurora, IL (US)

(73) Assignee: XENTRIS WIRELESS, LLC, Addison, IL (US)

(21) Appl. No.: 13/775,729

(22) Filed: Feb. 25, 2013

Related U.S. Application Data
(60) Provisional application No. 61/728,637, filed on Nov. 20, 2012.

(51) Int. Cl. F21V 33/00

(52) U.S. Cl. CPC F21V 33/0004
USPC 362/382

(57) ABSTRACT

An illuminated interface cable with a connector interface on at least one end. A light circuit including a light and a mechanical switch, the light circuit configured to energize the light upon actuation of the mechanical switch. The light and momentary switch coupled to the connector interface, the light oriented to illuminate an interconnection area of the connector interface. The light may be provided, for example, as a light emitting diode.

### BACKGROUND

1. Field of the Invention

This invention relates to power and/or data cables for electronic apparatus. More particularly, the invention relates to a power and/or data cable for electronic apparatus with an illuminated interconnection interface.

2. Description of Related Art

Electronic apparatus, particularly portable electronic devices such as cellular telephones, laptops and/or tablet computers utilize cables for power, charging and/or data exchange.

A typical standardized interface for many electronic devices is the microUSB interface. A microUSB interface provides both power and data interconnections in a very small space, reducing the mating connector dimensions required on the electronic device and thereby enabling electronic devices that are smaller and therefore have increased portability.

Electronic devices may require interconnection with the cable, for example for charging as a part of daily routine, often performed for example by the users bedside so that the device recharges overnight, while still available for use even while charging.

A problem with the prior cables is that interconnecting the male cable connector interface to the electronic device female interface may be difficult as the interfaces are small and require relatively precise alignment prior to interconnection. It may be particularly difficult to align for interconnection in poor lighting conditions and/or darkness as the female electronic device interface may be a recessed socket preventing alignment by touch.

Illuminated cables, wherein the cable illuminates to indicate an energized status are known. However, a constantly illuminated cable may waste power and/or create undesireable illumination, for example in places/times where darkness may be preferred, such as a bedroom when another is person is sleeping.

Convenience, cost and/or reliability may be significant factors of commercial success in the consumer electronic market.

Therefore, an object of the invention is to provide a cable that overcomes deficiencies in the prior art.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic representation of an exemplary illuminated interface cable with USB and microUSB connector interfaces.

FIG. 2 is a schematic circuit diagram for an illuminated interface cable wherein the light is an LED activated by a momentary switch.

FIG. 3 is a schematic isometric view of a connection interface with a light for illuminating the connection area, the light and momentary switch to activate the light enclosed within an overbody of the connector.

FIG. 4 is a schematic isometric view of a connection interface with a light for illuminating the connection area, demonstrating a momentary switch with an external button surface.

FIG. 5 is a schematic isometric view of a connection interface with a light for illuminating the connection area, demonstrating a slide switch.

FIG. 6 is a schematic isometric view of a connection interface with a light for illuminating the connection area, demonstrating a momentary switch with a bias provided by the overbody.

FIG. 7 is a schematic isometric view of a USB connection interface.

FIG. 8 is a schematic isometric view of a car adapter connection interface.

FIG. 9 is a schematic isometric view of a wall adapter connection interface.

FIG. 10 is a schematic isometric view of a connection interface with a light for illuminating the connection area, demonstrating selective illumination of the connection area for ease of interconnection with minimized light pollution.

### DETAILED DESCRIPTION

The inventors have recognized that a cable with a capacitive switch, activating a light emitting diode (LED) light illuminating the area of the connection interface whenever the capacitive switch surface is touched, also has the drawback of illuminating whenever the capacitive switch surface contacts other surfaces with suitable capacitive characteristics and/or may not be reliably actuated when the user fails to have suitable body capacitance, for example due to insulating coatings, a grounded environment and/or humidity pre-emptively inhibiting charging and/or dissipating any charge that may be present. Where a capacitive switch is applied to an interface cable, as the operator for a light or the like the capacitive switch may actuate by accident if accidentally shifted into contact with a suitable surface, turning on the light and disturbing those nearby.

As referenced herein, a mechanical switch is defined as a switch requiring physical movement of at least a portion of the switch to engage or disengage electrical continuity across the switch.

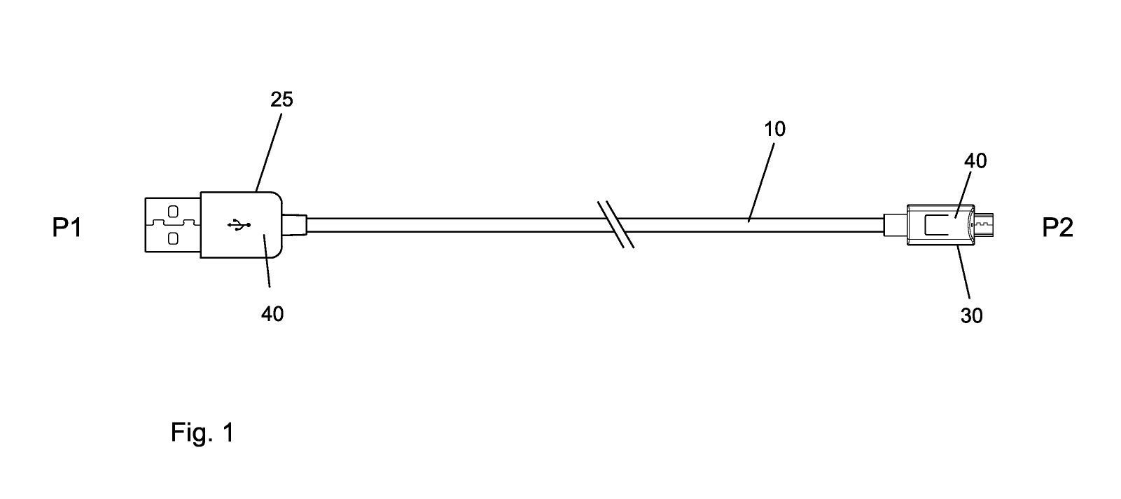

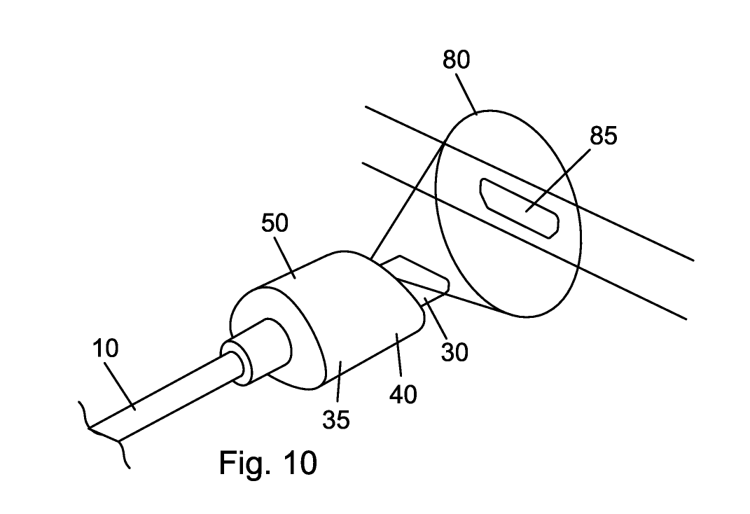

As demonstrated in FIGS. 1-10, an illuminated interface cable 10 is provided with a mechanical switch 15 that activates a light 20 illuminating the interface area 80 for ease of interconnection, with minimal light pollution outside of the interface area 80. The interface area 80 may be defined as the area into which the interface is inserted to interconnect two interfaces with one another. The illuminated interface cable 10 enables, for example, illumination sufficient to guide interconnection with a corresponding interface 85 of, for example, electronic devices in a dark area without disturbing the overall light levels of the dark area, such as a bedroom at night, for example as shown in FIG. 10.

The cable 10 may be a standard interface cable, for example demonstrated in FIG. 1 as a shielded four conductor data/power cable 10 with a standard USB interface 25 at one end, P1, and a microUSB interface 30 at a second end, P2.

A light 20, such as a light emitting diode (LED) 22, is provided, for example, at the microUSB interface 30 end P2, the light 20 preferably directed primarily upon the direction of insertion for the mating microUSB connector. The light 20 may be encapsulated into the overbody 35 of the connector, for example applied within the polymeric overbody 35 of the connector hand grip surface 40. By recessing the LED 22 within an aperture 45 of the surrounding overbody 35 open to the interconnection end, the light output may be guided toward the desired interface area 80, minimizing light pollution outside of the interface area 80.

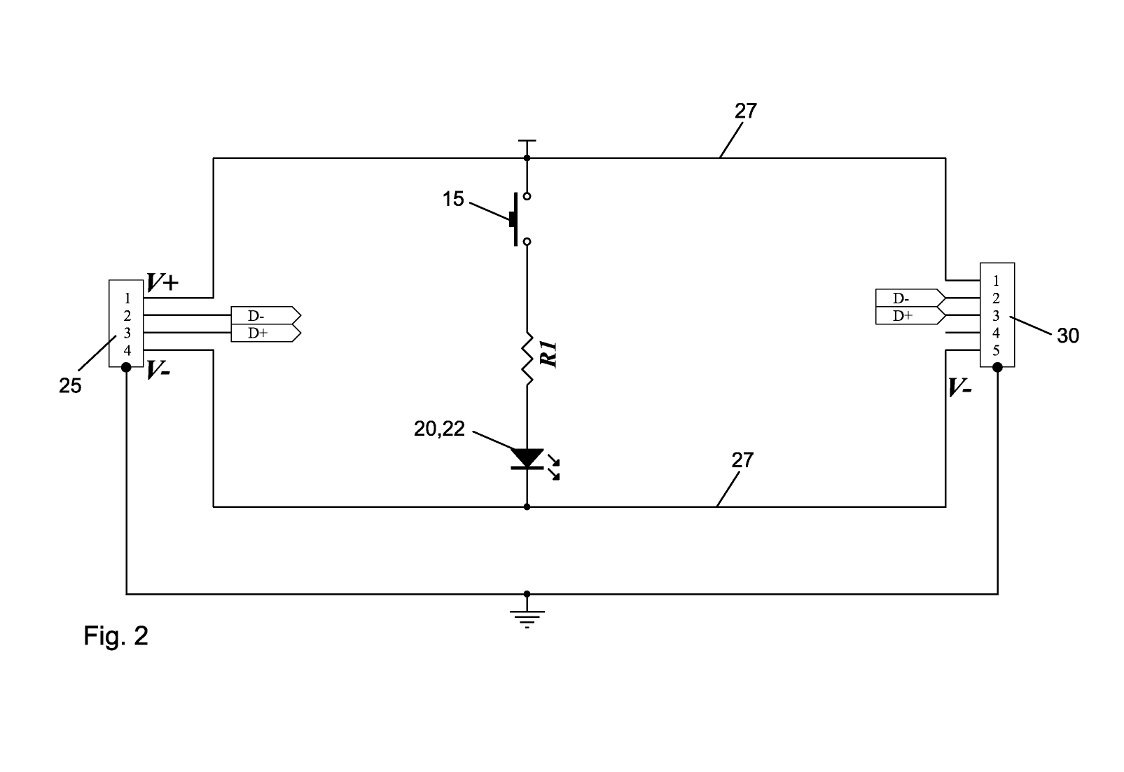

The light 20 may be energizable via an LED circuit applied between a first and a second power conductor 27 of the cable 10, for example as shown in FIG. 2. The LED 22 and associated resistor R1 requires minimal current to operate, limiting the potential for disrupting the operation of the cable 10 as a power supply for the electronic device.

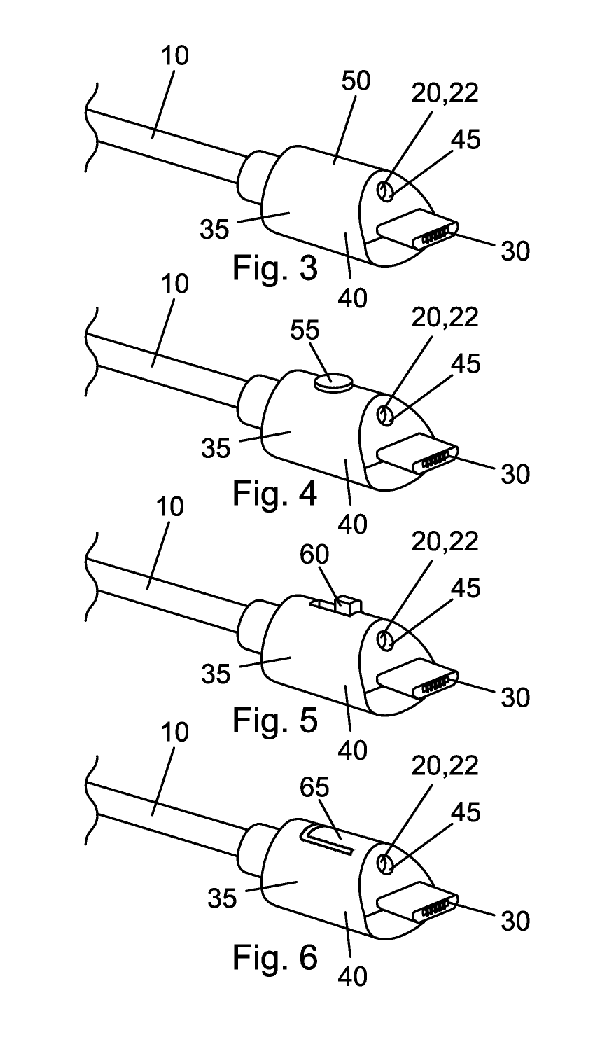

Any of several embodiments of the switch 15 may be applied, for example as shown in detail in FIGS. 3-6. FIG. 3 demonstrates a connector overbody 35 wherein the switch 15 is a momentary-type switch, enclosed within the connector overbody 35, activated by squeezing a deflectable portion 50 of the connector overbody 35 to overcome a bias provided by the material of the connector overbody 35, which otherwise maintains the switch 15 in an open circuit or off position and thereby the light 20 is not energized unless the overbody 35 is squeezed at the deflectable portion 50. The overbody 35 may be provided as a polymeric material, molded/sealed around the selected connection interface, encapsulating the switch 15 and LED circuit, inhibiting fouling and/or moisture contamination of the LED circuit.

FIG. 4 demonstrates a connector overbody 35 with an external button surface 55 that activates the momentary switch 15 when depressed. The switch 15 may be momentary or include a retention function maintaining the light 20 in the energized/illuminated state until the connector overbody 35 is again depressed. The external button surface 55 may be a separate element movable within a cavity of the overbody 35, or a protrusion of the overbody 35 of the connector, useful as feedback of the location of the switch 15.

FIG. 5 demonstrates a moveable switch 15 that activates when the switch handle 60 is moved from the off position to the on position. The switch 15 may be spring biased towards the off position or self retaining in the on and/or off position, enabling the light 20 to be turned on without requiring the user to maintain a constant pressure upon the switch 15 and/or overbody 35 of the connector.

FIG. 6 demonstrates a flush button activation embodiment wherein the overbody 35 may provide a bias to the off position of the switch wherein the user flexes an overbody lever portion 65 against the switch 15 to activate it and the bias provided by the overbody 35 then removes the activation when the pressure is removed from the overbody lever portion 65.

The several embodiments have been demonstrated with respect to the microUSB interface 30. Alternatively, one skilled in the art will appreciate that the connection interface may be any standard or proprietary connection interface, such as the USB interface 25 and/or RJ45 interfaces or the like.

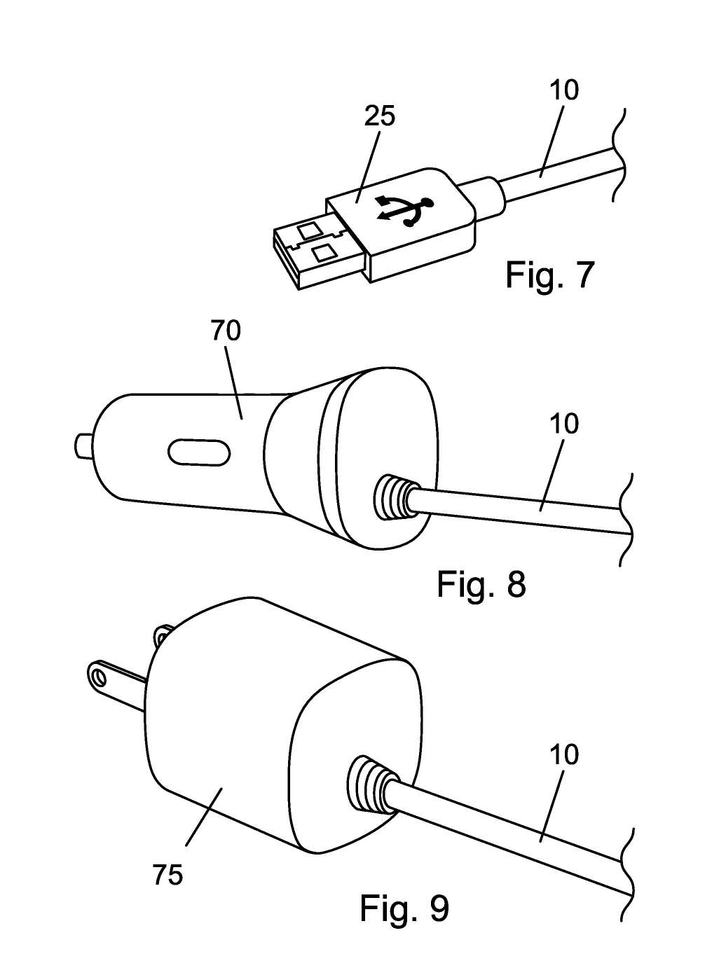

In further embodiments the cable 10 may be applied with any of a range of interconnections opposite the illuminated connector interface end and/or with an illuminated connector interface at both ends of the cable. Alternatively, instead of the USB or similar communications cable type interface, for example according to FIG. 7, the non-illuminated connection interface end of the cable may be provided with any desired interface and/or directly connected module, such as an automobile cigarette lighter adapter 70, for example as shown in FIG. 8 or a wall outlet adapter 75, for example as shown in FIG. 9.

One skilled in the art will appreciate that the illuminated interface cable provides a positive engagement characteristic for activating the illumination that is unlikely to be inadvertently activated by mere incidental contact with surrounding objects. Further, the circuit requirements for the illuminated interface cable enables addition of the illumination functionality with minimal additional cost and high reliability.

Table of Parts

| | |
|---|---|
| 10 | cable |
| 15 | switch |
| 20 | light |
| 22 | light emitting diode |
| 25 | USB interface |
| 27 | power conductor |
| 30 | microUSB interface |
| 35 | overbody |
| 40 | connector hand grip surface |
| 45 | aperture |
| 50 | deflectable portion |
| 55 | external button surface |
| 60 | switch handle |
| 65 | lever portion |
| 70 | automobile cigarette lighter adapter |
| 75 | wall outlet adapter |
| 80 | interface area |
| 85 | interface |

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. An illuminated interface cable, comprising:
a cable with a connector interface on at least one end;
a light circuit including a light and a mechanical switch; the light circuit configured to energize the light upon actuation of the mechanical switch;
the light and the mechanical switch coupled to the connector interface, the light oriented to illuminate an interconnection area of the connector interface.

2. The illuminated cable of claim 1, wherein the light is a light emitting diode.

3. The illuminated cable of claim 2, wherein the light emitting diode is arranged in series with the switch and a resistor, between a first and a second power conductor of the cable.

4. The illuminated cable of claim 1, wherein the light and mechanical switch are encapsulated within a polymeric overbody of the connector interface.

5. The illuminated cable of claim 1, wherein the light is recessed within an aperture of the overbody, the aperture open to the interconnection area.

6. The illuminated cable of claim 4, wherein the overbody includes a deflectable portion of the overbody operable to actuate the mechanical switch.

7. The illuminated cable of claim 4, further including a lever portion of the overbody operable to actuate the mechanical switch, the lever portion biased to provide the mechanical switch with a disengaged steady state.

8. The illuminated cable of claim 4, further including a switch handle coupled to the mechanical switch extends outward from the overbody.

9. The illuminated cable of claim 8, wherein the switch handle is spring biased towards an off position.

10. The illuminated cable of claim 8, wherein the switch handle is self retaining in an off and an on position.

11. The illuminated cable of claim 1, wherein each of the ends of the cable are provided with the connector interface, the light circuit and the mechanical switch;
both of the light circuits configured to energize the respective light upon actuation of the respective mechanical switch; and
each of the lights oriented to illuminate the respective interconnection area of the respective connector interface.

12. The illuminated cable of claim 1, wherein the mechanical switch is biased toward an off position, momentarily actuatable by application of force to the mechanical switch.

13. The illuminated cable of claim 1, wherein one end of the cable is one of a wall outlet adapter and a cigarette lighter adapter.

14. The illuminated cable of claim 1, wherein the connection interface is a microUSB interface.

15. The illuminated cable of claim 1, wherein the connection interface is a USB interface.

16. A method for manufacturing an illuminated interface cable, comprising the steps of:
providing a cable with a connector interface on at least one end;
encapsulating a light circuit including a light and a mechanical switch, the light circuit configured to energize the light upon actuation of the mechanical switch, within a polymeric overbody around the connector interface; and
the light and mechanical switch coupled to the connector interface, the light oriented to illuminate an interconnection area of the connector interface.

17. The method of claim 16, wherein each of the ends of the cable are provided with the connector interface, the light circuit including the light and the mechanical switch;
both of the light circuits configured to energize the respective light upon actuation of the respective mechanical switch; and
each of the lights oriented to illuminate the respective interconnection area of the respective connector interface.

18. The method of claim 16, wherein the light is recessed within an aperture of the overbody, the aperture open to the interconnection area.

19. The method of claim 16, wherein the overbody includes a deflectable portion of the overbody operable to actuate the mechanical switch.

20. The method of claim 16, wherein the light is a light emitting diode.
